(19) United States
(12) Patent Application Publication
(10) Pub. No.: US 2009/0122677 A1
(43) Pub. Date: May 14, 2009

(54) Recording medium, method and apparatus for managing a file system information of the recording medium

(76) Inventor: Sung Wan Park, Gyeonggi-do (KR)

Correspondence Address: HARNESS, DICKEY & PIERCE, P.L.C., P.O. BOX 8910, RESTON, VA, 20195, US

(21) Appl. No.: 11/666,235

(22) PCT Filed: Dec. 21, 2004
(86) PCT No.: PCT/KR2004/003384

§ 371 Date: Apr. 25, 2007

(51) Int. Cl. G11B 20/18; G11B 7/24

(52) U.S. Cl. 369/53.17; 369/275.3; G9B/20.046

(57) ABSTRACT

A recording medium, method and apparatus for managing a file system information of the ‘recording medium are disclosed. Herein, information for identifying a file system type (or a file system identifier) within a high density recording medium, such as a blu-ray disc, is recorded, and such a file system identifier is used in the method and apparatus for recording and reproducing the recording medium. The file system identifier is also used in a method for recording the file system identifier and initializing the same, when initializing the recording medium.

### TECHNICAL FIELD

The present invention relates to a recording medium, method and apparatus for managing a file system information of the recording medium and, more particularly, to a reproducing method and apparatus for recording information that can identify types of file systems included in a high density recording medium, such as a blu-ray disc, and using such information for recording and reproducing the recording medium, and also to a method for recording and initializing the information that can identify the types of file system upon initialization of the recording medium.

### BACKGROUND ART

Optical discs are widely used as a recording medium for recording mass data. Presently, among a wide range of optical discs, a new high density optical recording medium (i.e., HD-DVD), such as a blu-ray disc (hereinafter referred to as “BD”), is under development for recording (or writing) and storing high definition video and audio data for a long period of time. Currently, the blu-ray disc (BD), which is known to be the next generation recording medium technology, is under development as an optical recording solution that is capable of having data significantly surpassing the conventional DVD.

Accordingly, the blu-ray disc (BD)-based optical recording and reproducing apparatus performs different recording and reproducing formats, depending upon the file system applied to the blu-ray disc (BD). Therefore, a file system standard should first be completed in order to develop the optical recording and reproducing apparatus. However, since a consolidated file system application solution is yet to be provided, there are many limitations in developing the blu-ray disc (BD)-based optical recording and reproducing apparatus.

### DISCLOSURE OF INVENTION

An object of the present invention devised to solve the problem lies on providing a recording medium, method and apparatus for managing a file system information of the recording medium that can substantially obviate one or more problems due to limitations and disadvantages of the related art.

Another object of the present invention devised to solve the problem lies on providing a systematic and standardized file system identifier within the recording medium.

Another object of the present invention devised to solve the problem lies on providing a method for initializing the recording medium including the file system identifier.

A further object of the present invention devised to solve the problem lies on providing an effective method and apparatus for recording and reproducing the recording medium using the file system identifier.

The object of the present invention can be achieved by providing a recording medium including a file system information area for recording a file system information within the recording medium, and a file system identifier area for recording a file system identifier, which identifies a type of the recorded file system.

In another aspect of the present invention, provided herein is a method for recording and reproducing a recording medium including identifying a file system identifier recorded on the recording medium, and if a corresponding file system is identified as non-recordable and non-reproducible, indicating the file system accordingly and canceling recording and reproducing operations.

In another aspect of the present invention, provided herein is a method for initializing a recording medium including initializing the recording medium based upon a specific file system, and recording an identifier, which is able to identify a type of the specific file system, within a specific area of the recording medium.

In another aspect of the present invention, provided herein is a method for initializing a recording medium including initializing the recording medium in accordance with any one of two file system types, which are different from one another, and recording an identifier, which is able to identify the initialized file system type, within a specific area of the recording medium.

In a further aspect of the present invention, provided herein, in a recording medium that is able to be recorded and reproduced in accordance with only a specific file system type, is an apparatus for recording and reproducing the recording medium including a recording and reproducing unit reading a file system identifier of the recording medium, and a controller determining whether a corresponding optical disc is recordable and reproducible, depending upon the read file system identifier, and canceling recording and reproducing operations, if the optical disc is determined to be non-recordable and non-reproducible.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates a general view of the present invention.

FIG. 2 illustrates an optical disc using a file system identifier according to the present invention and a usage mode of an optical recording and reproducing apparatus.

FIG. 3 illustrates a recording and reproducing method using the file system identifier according to the present invention.

FIG. 4 illustrates a method for recording the file system identifier on an optical disc according to a first embodiment of the present invention.

FIGS. 5A and 5B illustrate a method for recording the file system identifier on an optical disc according to a second embodiment of the present invention.

FIG. 6 illustrates an optical recording and reproducing apparatus according to the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

In this detailed description, “recording medium” refers to all types of medium that can record data and broadly includes all types of medium regardless of the recording method, such as an optical disc, a magnetic tape, and so on. Hereinafter, for simplicity of the description of the present invention, the optical disc and, more specifically, the “blu-ray disc (BD)” will be given as an example of the recording medium proposed herein. However, it will be apparent that the spirit or scope of the present invention may be equally applied to other types of recording medium.

Also, a definition of the term “file system” is as follows. Data recorded on a disc are controlled in the form of files, and the “file system” refers to information including metadata for controlling the files recorded on the disc in accordance with a specific method. In other words, the file system includes property information for each file and recording position within the disc and also includes information for an overall file control, such as the relation between each of the files. Most particularly, and generally, when the standard of an optical disc of a specific type is decided, the file system that is applied to the corresponding optical disc is standardized accordingly. For example, in a rewritable blu-ray disc (BD-RE), the disc is standardized as “Blu-ray Disc Rewritable Format Part 2, File System Specification Version 1.0 (hereinafter referred to as <BD-RE Version 1.0>)”.

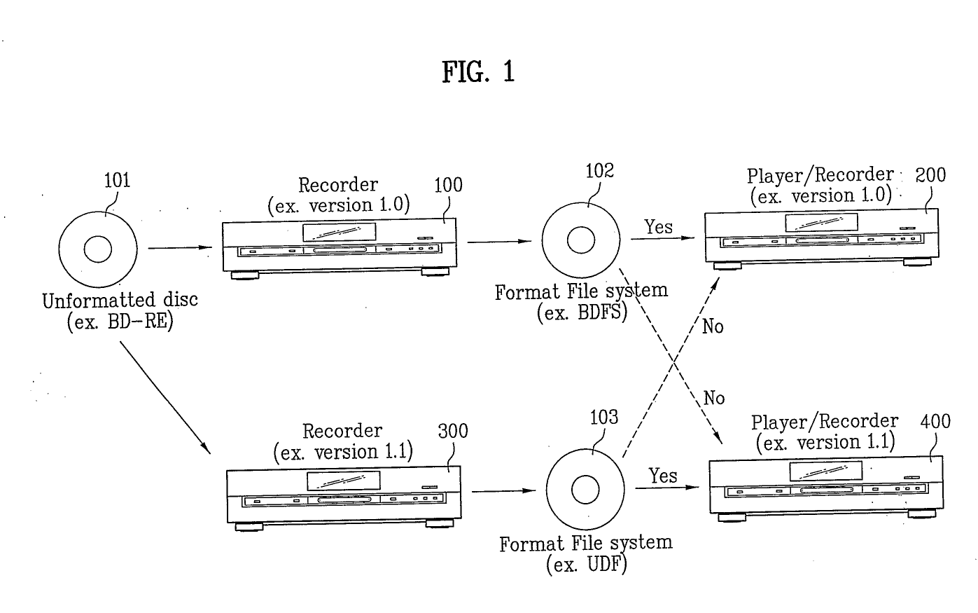

Accordingly, the file system that is basically applied to the “BD-RE Version 1.0” has an independent format of “Blu-ray Disc File System (BDFS)”. However, in a new format that will be developed, such as “BD-RE Version 1.1”, a different file system format may be applied. In order to simplify the description of the present invention, it will be assumed that the file system applied to “BD-RE Version 1.1” is based on a “universal disc format (UDF)”, which is applied to the conventional DVD. More specifically, the file system applied to the optical disc can be developed by various methods, and the file systems that are different from one another are not inter-compatible. Therefore, it is apparent that when an optical disc (e.g., disc version 1.1), which is only controlled by a specific type of file system, is loaded in an optical recording and reproducing apparatus (e.g., apparatus version 1.0) that supports a different type of file system, the optical disc cannot be recorded and/or reproduced. A more detailed description of the same will follow with reference to FIG. 1.

FIG. 1 illustrates a general view of the present invention, wherein a usage mode between optical recording and reproducing apparatuses (100, 200, 300, and 400) and optical discs (101, 102, and 103) having a file system written thereon. Accordingly, each of the optical recording and reproducing apparatuses (100, 200, 300, and 400) according to the present invention is an apparatus that can record and reproduce optical discs of various standards. Depending upon the design, the optical recording and reproducing apparatus may only record and reproduce optical discs of a specific standard (e.g., blu-ray disc (BD)). Alternatively, the optical recording and reproducing apparatus may only have reproducing functions and no recording functions. Most particularly, since the present invention is related to the development of the blu-ray disc (BD)-based optical recording and reproducing apparatus, a blu-ray disc player (BD-Player) or a blu-ray disc recorder (BD-Recorder) will be given as examples in the description of the present invention.

In the present invention, it is assumed that the optical recording and reproducing apparatus 100 is a BD-Recorder supporting “BD-RE Version 1.0”, and the optical recording and reproducing apparatus 200 is one of a BD-Player and a BD-Recorder supporting “BD-RE Version 1.0”. It is also assumed that the optical recording and reproducing apparatus 300 is a BD-Recorder supporting “BD-RE Version 1.1”, and the optical recording and reproducing apparatus 400 is one of a BD-Player and a BD-Recorder supporting “BD-RE Version 1.1”. Furthermore, it is assumed that the file system used in the “BD-RE Version 1.0” is “BDFS”, and the file system used in the “BD-RE Version 1.1” is “UDF”. Therefore, when a blank disc 101 or an unformatted disc 101 is formatted by using the optical recording and reproducing apparatuses 100 and 300, the file system of the optical disc 102 is formatted as “BDFS” (i.e., BDFS-formatted), and the file system of the optical disc 103 is formatted as “UDF” (i.e., UDF-formatted).

When the formatted optical discs 102 and 103 are recorded and reproduced by using the optical recording and reproducing apparatuses 200 and 400, the optical recording and reproducing apparatus 200, which can only support the “BDFS” file system (i.e., BDFS-supported), can record and reproduce the optical disc 102 which is formatted to have the same file system (i.e., BDFS). However, the BDFS-supported optical recording and reproducing apparatus 200 cannot record and reproduce the UDF-supported optical disc 103. Similarly, the optical recording and reproducing apparatus 400, which can only support the “UDF” file system (i.e., UDF-supported), can record and reproduce the UDF-formatted optical disc 103 but cannot record and reproduce the BDFS-formatted optical disc 102.

Also, when an optical disc formatted to have a different file system is loaded, each of the optical recording and reproducing apparatuses 200 and 400 identifies the loaded optical disc as an unformatted disc or is unable to determine the format type of the loaded disc. In this case, there lies a problem in that the optical recording and reproducing apparatus may require the user to format the loaded optical disc, so that the apparatus can forcibly format the loaded disc by applying the file system which the corresponding apparatus supports. Accordingly, in order to resolve such problems, the optical recording and reproducing apparatus 200 and 400 should always be able to identify the file system applied to the loaded optical disc 102 and 103. Therefore, in the present invention, file system identifiers are recorded on the optical disc, thereby enabling the apparatus to identify the file system of the optical disc loaded therein.

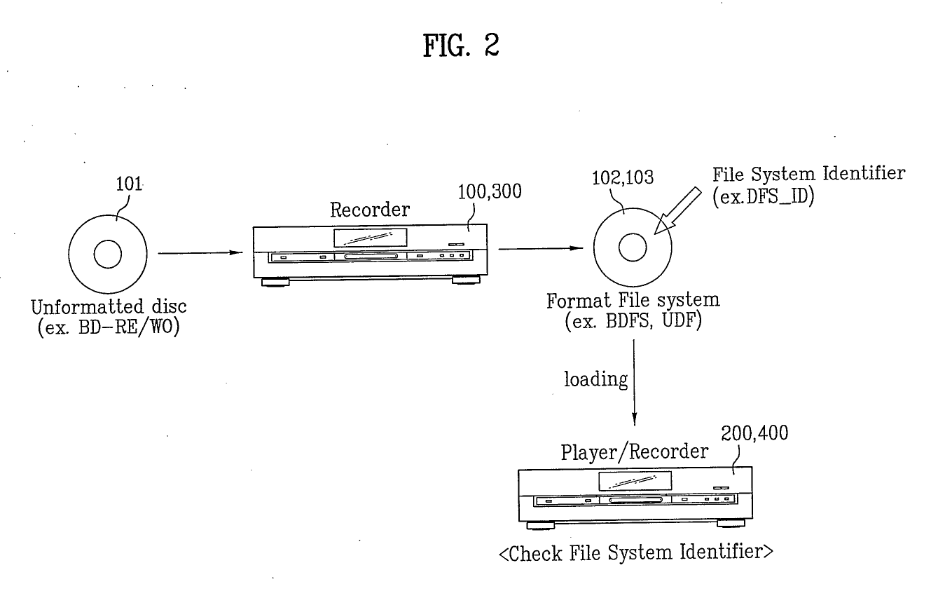

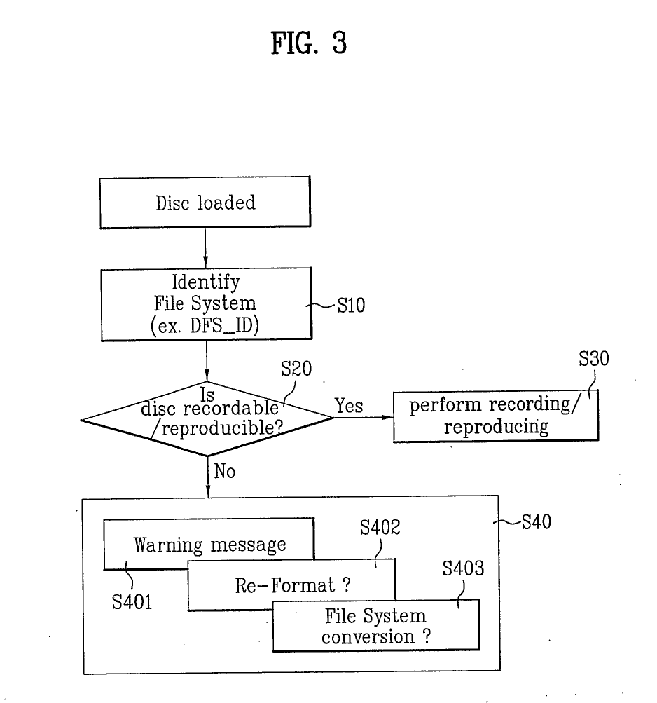

FIG. 2 illustrates an optical disc using a file system identifier according to the present invention and a usage mode of an optical recording and reproducing apparatus. As the optical recording and reproducing apparatus 100 and 300 formats an optical disc, 101 to have the same file system as itself, the apparatus records a set of information for identifying the type of the corresponding file system at a specific position on the optical disc. Hereinafter, such information will be referred to as a “disc file system identifier (DFS_ID)”. Accordingly, a set of specific file system information (i.e., BDFS or UDF) and an identifier (i.e., DFS_ID) are recorded on each of the formatted discs 102 and 103. Thereafter, when the formatted optical disc 102 or 103 is loaded in one of the optical recording and reproducing apparatuses 200 and 400, the apparatus 200 or 400 identifies the file system identifier (DFS_ID), which is recorded on the optical disc, thereby being able to accurately identify the file system applied to the loaded optical disc. Thus, the error of not being able to identify the file system of the loaded optical disc can be minimized. The operation of the optical recording and reproducing apparatus will now be described in detail with reference to FIG. 3.

FIG. 3 illustrates a flow chart of a recording and reproducing method using the file system identifier according to the present invention. When the optical disc is loaded, the optical recording and reproducing apparatus identifies and file system identifier (DFS_ID) recorded on a specific position of the optical disc (S10). And, by comparing the identified file system identifier (DFS_ID) with the file system supported by the optical recording and reproducing apparatus, the apparatus determines whether the loaded optical disc can be recorded and reproduced (S20). As described in the above process step, when the apparatus determines that the optical disc can be recorded and reproduced, the apparatus performs the general recording and reproducing operations (S30). However, when the apparatus determines that the optical disc cannot be recorded and reproduced (i.e., non-recordable and non-reproducible), the apparatus discontinues (or cancels) the recording and reproducing operations and performs the following process steps either sequentially or independently (S40).

When the optical recording and reproducing apparatus determines the loaded optical disc to be a non-recordable and non-reproducible disc, the apparatus displays a warning message to the user (S401). The warning message may be written and displayed by a general method, such as “This system cannot support the current disc (file system error)”. Also, the optical recording and reproducing apparatus may display a guidance notice advising the user to format the loaded disc (S402). For example, the apparatus may provide a notice, such as “The file system of the data recorded in the current disc does not match the file system of the current system. To continue usage, please re-format the disc.” Further, the optical recording and reproducing apparatus may display a guidance notice advising the user to convert (or modify) the file system of the disc (S403). For example, the apparatus may provide a notice, such as “The file system of the data recorded in the current disc does not match the file system of the current system. To continue usage, please convert the file system of the current disc to another type that can be supported by the current system.” As described above, the optical recording and reproducing apparatus can be primarily operated when the optical disc provides the corresponding (or matching) file system identifier (DFS_ID).

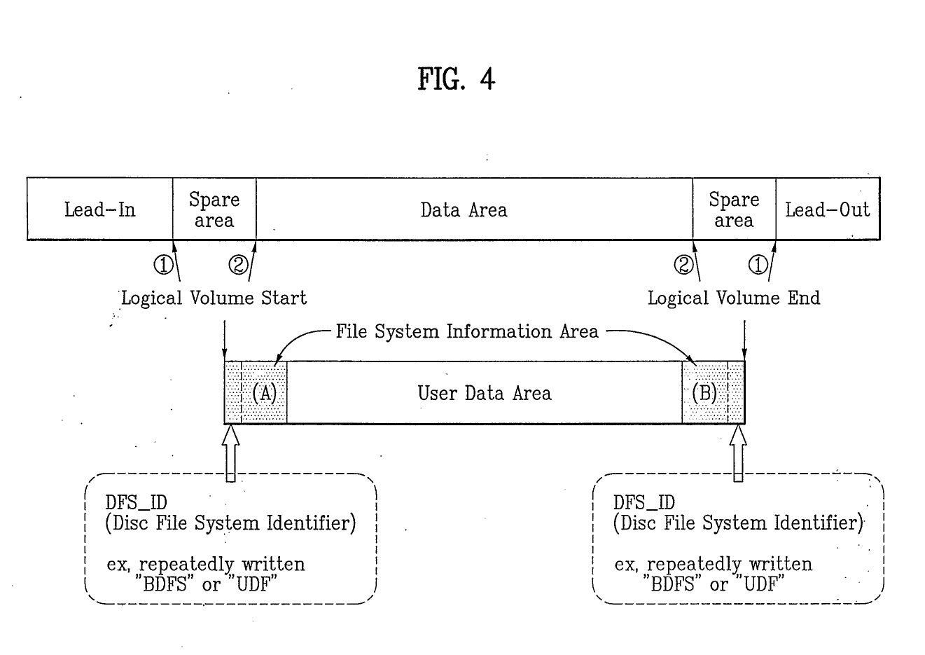

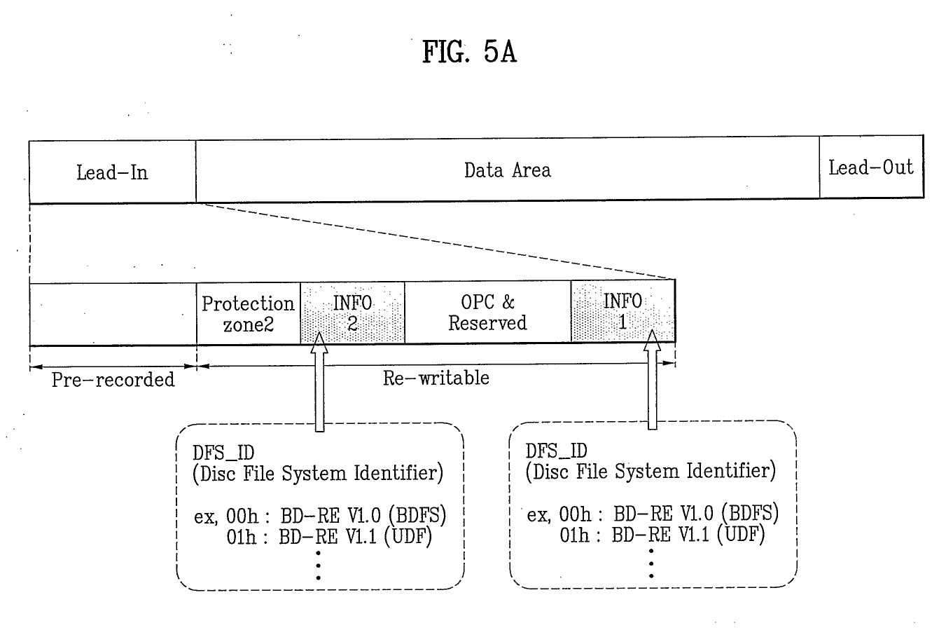

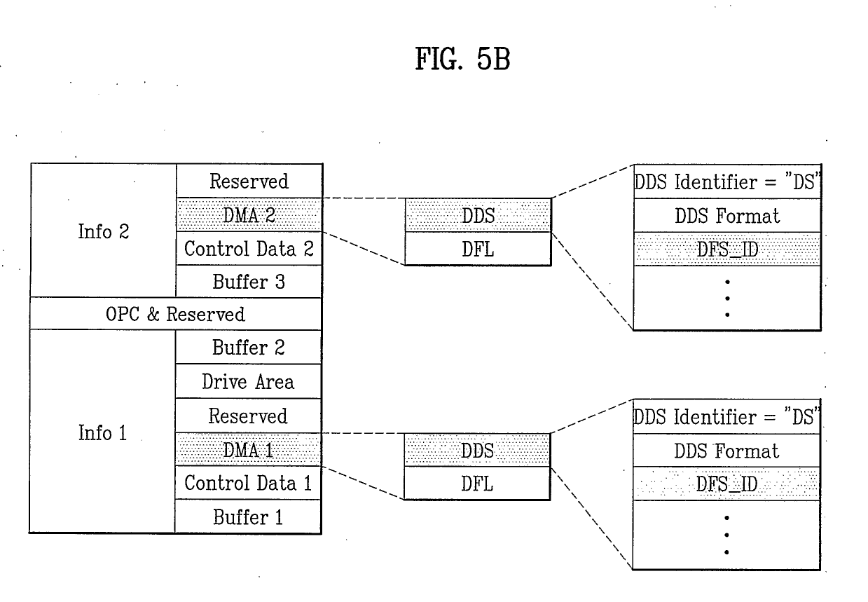

The method for recording the file system identifier (DFS_ID) in the optical disc will now be described in detail with reference to FIGS. 4 to 5B. In the present invention, the method for recording the file system identifier (DFS_ID) in the optical disc is described according to two different embodiments of the present invention. In the first embodiment, the file system identifier (DFS_ID) is recorded within a file system information area (shown in FIG. 4). And, in the second embodiment, the file system identifier (DFS_ID) is recorded within an optical disc control area (shown in FIGS. 5A and 5B). However, the present invention is not limited only to the proposed embodiments, and therefore, the file system identifier (DFS_ID) is not limited to a specific type or method and may adopt any type or method that can identify a different file system.

FIG. 4 illustrates a method for recording the file system identifier on a high density optical disc according to a first embodiment of the present invention. More specifically, FIG. 4 illustrates a method for recording the file system identifier (DFS_ID) to a file system information area. The optical disc includes 3 different areas: a disc control area (i.e., a lead-in area and a lead-out area), a data area, and a spare area. Each of the lead-in area and the lead-out area is located at the inner circumference and the outer circumference of the optical disc, respectively. The data area is located between the lead-in area and the lead-out area. Also, the spare area is located on each of the beginning point and ending point of the data area. Furthermore, a user data area exists between the two spare areas, wherein the actual data is recorded. If the spare area is not included in the optical disc (which may vary depending upon the format of the disc, for example, when recording AV streams, the spare area is generally not assigned to the disc), the entire data area becomes the user data area. Most particularly, since the user data area is controlled by the file system, the user data area may also be referred to as a logical volume.

Therefore, referring to FIG. 4, if the spare area does not exist, the user data area may start from the beginning point of the data area (i.e., Logical Volume Start \textcircled{1}). Alternatively, if the spare area exists, the user data area may start from the beginning of the recordable area (i.e., Logical Volume Start \textcircled{2}). The ending point of the user data area (i.e., Logical Volume Ends \textcircled{1} and \textcircled{2}) may be decided by using the same method. More specifically, in case of a re-writable blue-ray disc (BD-RE), for example, a file system information area may exist before the front portion (A) and after the end portion (B) of the user data area, and the file system information applied to the optical disc is recorded in the corresponding area. Evidently, it is apparent that the file system information area may be located at a different position within the user data area depending upon the standard of the optical disc.

The present invention relates to recording a file system identifier at the beginning point and/or the ending point of the file system information area. In other words, when using the re-writable blu-ray disc (BD-RE Version 1.0, using BDFS), for example, no other information is recorded within a specific size of the beginning portion (i.e., LBN0 to LBN511, wherein LBN represents a logical block number). In this area, a file system name “BDFS” is repeatedly recorded as the file system identifier (DFS_ID), thereby enabling the file system type that is adopted in the corresponding optical disc to be easily identified. Accordingly, a zero value (00h) may be repeatedly recorded in the above-described area as the file system identifier (DFS_ID).

Also, when using the re-writable blu-ray disc (BD-RE Version 1.1, using UDF), for example, no other information is recorded within a specific size of the beginning portion (in this case, the specific size will be different from that of BD-RE Version 1.0). In this area, a file system name “UDF” is repeatedly recorded as the file system identifier (DFS_ID). Similarly, the file system identifier (DFS_ID) may be recorded on the outermost portion of the file system information area, having the file system information recorded therein, wherein the file system information area is included in the end portion (B) of the user data area. Herein, the recording method is identical to that of the front portion (A), as described above, and so the description of the same will be omitted for simplicity.

Furthermore, as described above, assuming that there exist two different types of file system, when the BDFS file system is used, the zero value (00h) is repeatedly recorded as the file system identifier (DFS_ID), and when the UDF file system is used, a separate file system identifier (DFS_ID) is not recorded in the same area, thereby enabling the different file systems (i.e., BDFS file system and UDF file system) to be distinguished from one another. Therefore, in the first embodiment a file system name of a corresponding file system identifier (DFS_ID) recorded on an innermost portion and/or an outermost portion of the file system information area is recorded in character forms. Alternatively, in order to distinguish two different types of file system, a zero value (00h) for only one of the file system type is repeatedly recorded, and a zero value (00h) for the other file system type is not repeatedly recorded.

FIGS. 5A and 5B illustrate a method for recording the file system identifier (DFS_ID) on an optical disc according to a second embodiment of the present invention. More specifically, FIG. 4 illustrates a method for recording the file system identifier (DFS_ID) within a control area of the optical disc. Herein, the control area of the optical disc refers to an area of the disc having the disc control information recorded therein with the exception of data area, which corresponds to the lead-in and lead-out areas of FIG. 5A. Most particularly, recording the file system identifier (DFS_ID) according to the present invention within the lead-in area is advantageous in that the lead-in area is the first area to be accessed when the optical disc is loaded.

FIG. 5A illustrates an example of using a re-writable blu-ray disc (BD-RE). Herein, when the disc is re-written, the lead-in area includes a pre-recorded area and a re-writable area. The re-writable area includes two information areas (INFO 1 and INFO 2), and a protection zone (protection zone 2). Diverse control information is recorded within the two information areas INFO 1 and INFO 2. The protection zone 2 prevents interruption between the OPC area, which calculates an optimum recording power, and the pre-recorded area. In the present invention, a file system identifier (DFS_ID) is recorded within at least any one of the two information areas INFO 1 and INFO 2. However, in this case, a specific byte is assigned, so as to define the file system identifier (DFS_ID) as “BD-RE Version 1.0, BDFS” when the specific byte is equal to “00h”, and as “BD-RE Version 1.1, UDF” when the specific byte is equal to “01h”. If there exist more file systems to be distinguished, the file system identifier (DFS_ID) may be serially defined as “02h”, “03h”, and so on.

FIG. 5B illustrates a method for recording the file system identifier (DFS_ID) within at least any one of the two information areas INFO 1 and INFO 2, shown in FIG. 5A, and most particularly, within a defect management area (DMA). More specifically, the first information area INFO 1 includes a drive area, a first defect management area (DMA 1), and a first data control area (Control Data 1), and the second information area INFO 2 includes a second defect management area (DMA 2) and a second data control area (Control Data 2). Herein, the DMA is an area assigned for managing defects in the disc. The lead-in area includes DMA 1 and DMA 2, the lead-out area includes DMA 3 and DMA 4. In other words, a total of 4 DMAs exists in a single disc, and each of DMA 1, DMA 2, DMA 3, and DMA 4 is used to repeatedly record identical information contents. Therefore, when recording the file system identifier (DFS_ID) according to the present invention within the DMAs, the same file system identifier (DFS_ID) is simultaneously recorded within each of the 4 file system identifiers (DFS_IDs). Such method is advantageous in that even when the file system identifier (DFS_ID) of any one of the 4 DMAs is defective or damaged, the file system identifier (DFS_ID) of any other DMA may be used instead, thereby protecting the file system identifier (DFS_ID).

In addition, the DMA includes a disc definition structure (DDS) information and a defect list (DL), and the file system identifier (DFS_ID) according to the present invention is recorded within the disc definition structure (DDS) information. When using the re-writable blu-ray disc (BD-RE), the disc definition structure (DDS) is an area for recording disc defect managing information as well as other disc control information. The size of the disc definition structure (DDS) area is equal to approximately 64 kilobytes (kB), which is sufficient for a large amount of control information to be recorded therein, and therefore, a large number of “Reserved Areas” exists. Hereinafter, the method for recording the file system identifier (DSF_ID) within the DDS information is identical to the method shown in FIG. 5A, wherein each file system is equally identified as “00h” and “01h” and is assigned with a file system identifier. Therefore, the second embodiment of the present invention records the file system identifier (DFS_ID) on a random position within the disc control area. However, it is preferable that the file system identifier (DFS_ID) is recorded within the DDS information of the DMA. Accordingly, the optical recording and reproducing apparatus can easily identify the file system type, and the file system identifier (DFS_ID) can be separately recorded in a plurality of regions (DMA 1, 2, 3 and 4), thereby protecting the file system identifier (DFS_ID).

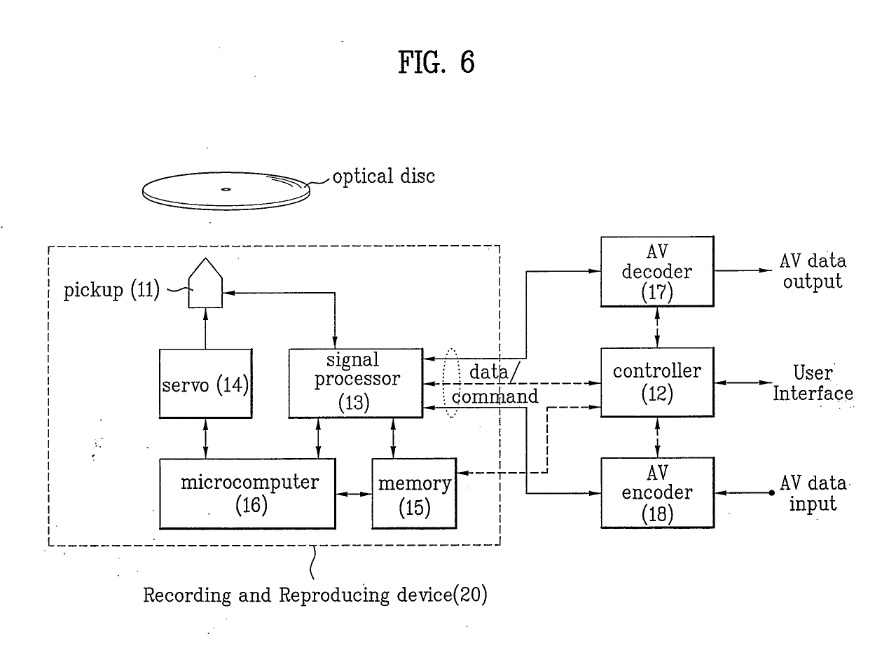

FIG. 6 illustrates a detailed structure of the optical recording and reproducing apparatus (100, 200, 300, and 400) using the file system identifier (DFS_ID) within the high density optical disc according to the present invention. The optical recording and reproducing apparatus basically consists of a recording and reproducing unit 20, which includes a pick-up unit 11 for reading control information including data and file system identifiers recorded within an optical disc, a servo 14 controlling the operations of the pick-up unit 11, a signal processor 13 either recovering the playback signal received from the pick-up unit 11 to a desired signal value, or modulating a signal to be recorded to an optical disc recordable signal and transmitting the modulated signal, a memory 15 temporarily storing and allowing usage of such control information, and a microcomputer 16 controlling the above operations. Furthermore, an AV decoder 17 performs final decoding of output data depending upon the controls of a controller 12. And, in order to perform the function of recording a signal on the optical disc, an AV encoder 18 converts an input signal into a signal of a specific format (e.g., an MPEG-2 transport stream) depending upon the controls of the controller 12 and, then, provides the converted signal to the signal processor 13.

The controller 12 controls the overall operations of the optical recording and reproducing apparatus. Herein, the controller 12 verifies and identifies, from the read file system identifier (DFS_ID), the file system applied to the corresponding optical disc and determines whether the loaded disc can be recorded and reproduced. Thereafter, if the controller 12 determines that the loaded disc cannot be recorded and reproduced, a command for canceling the operation of the optical recording and reproducing unit 20 is transmitted. Subsequently, as shown in S401, S402, and S403 of FIG. 3, the controller 12 transmits (or displays) a warning message and/or guidance notice to the user and, also, performs the requests made by the user through the user interface. More specifically, in accordance with the user's request, the controller 12 transmits a command to the recording and reproducing unit 20 corresponding to reformatting the optical disc or converting the file system.

In addition, when an unformatted disc is loaded, and when the user requests for an initialization, the controller 12 initializes the disc in accordance with the specific file system supported by the controller 12 itself. Also, the controller 12 transmits a command to the recording and reproducing unit 20 enabling a specific file system identifier (DFS_ID) to be recorded within a specific area of the optical disc by using any one of the above-described methods according the preferred embodiments of the present invention. Evidently, such a process applies not only to the initialization of the optical disc, but also to the re-initialization of the optical disc. Herein, the file system identifier (DFS_ID) can be recorded on one of the specific areas within the optical disc including the file system information area (shown in FIG. 4), information areas INFO 1 and INFO 2 of the control area (shown in FIG. 5A), and the disc definition structure (DDS) within the defect management area (DMA).

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention provides a recording medium, method and apparatus for managing a file system information of the recording medium, which can enable an effective usage of the optical disc without any critical errors, even when the different file systems are applied to the optical disc and the optical recording and reproducing apparatus, thereby providing more convenient functions to the users.

1. A recording medium, comprising:
a file system information area for recording a file system information within the recording medium; and
a file system identifier area for recording a file system identifier, which identifies a type of the recorded file system.

2. The recording medium of claim 1, wherein the file system identifier area is included the file system information area.

3. The recording medium of claim 2, wherein the file system identifier area is included within a front portion of the file system information area.

4. The recording medium of claim 2, wherein the file system identifier area is included within an end portion of the file system information area.

5. The recording medium of claim 1, wherein the file system identifier area is included within a control area of the recording medium.

6. The recording medium of claim 5, wherein the file system identifier area is included in a defect management area (DMA) of the recording medium.

7. The recording medium of claim 6, wherein the file system identifier area is included in a disc definition structure (DDS) area within the defect management area (DMA).

8. The recording medium of claim 1, wherein the recording medium is a re-writable blu-ray disc (BD-RE).

9. A method for recording and reproducing a recording medium, comprising:
identifying a file system identifier recorded on the recording medium; and
if a corresponding file system is identified as non-recordable and non-reproducible, indicating the file system accordingly and canceling recording and reproducing operations.

10. The method of claim 9, further comprising, when the file system is non-recordable and non-reproducible, verifying reformatting of the corresponding file system.

11. The method of claim 9, further comprising, when the file system is non-recordable and non-reproducible, verifying conversion of the corresponding file system to a recordable and reproducible file system.

12. A method for initializing a recording medium, comprising:
initializing the recording medium based upon a specific file system; and
recording an identifier, which is able to identify a type of the specific file system, within a specific area of the recording medium.

13. The method of claim 12, wherein the specific area of the recording medium having the identifier recorded therein is a file system information area.

14. The method of claim 12, wherein the specific area of the recording medium having the identifier recorded therein is a control area of the recording medium.

15. The method of claim 12, wherein the specific area of the recording medium having the identifier recorded therein is a defect management area (DMA).

16. The method of claim 12, wherein the specific area of the recording medium having the identifier recorded therein is a disc definition structure (DDS) area within the defect management area (DMA).

17. A method for initializing a recording medium, comprising:
initializing the recording medium in accordance with any one of two file system types, which are different from one another; and
recording an identifier, which is able to identify the initialized file system type, within a specific area of the recording medium.

18. The method of claim 17, wherein the two different file system types are a blu-ray disc file system (BDFS) file system and a universal disc format (UDF) file system.

19. The method of claim 18, wherein, when the recording medium is initialized in accordance with the BDFS file system, a zero value is recorded as a file system identifier, which is able to identify the file system type, within the specific area of the recording system.

20. The method of claim 19, wherein, when the recording medium is initialized in accordance with the UDF file system, a zero value is recorded as a file system identifier, which is able to identify the file system type, within the specific area of the recording system.

21. In a recording medium that is able to be recorded and reproduced in accordance with only a specific file system type, an apparatus for recording and reproducing the recording medium comprising:
a recording and reproducing unit reading a file system identifier of the recording medium; and
a controller determining whether a corresponding optical disc is recordable and reproducible, depending upon the read file system identifier, and canceling recording and reproducing operations, if the optical disc is determined to be non-recordable and non-reproducible.
